(19) United States
(12) Patent Application Publication
(10) Pub. No.: US 2015/0153823 A1
(43) Pub. Date: Jun. 4, 2015

(54) DISPLAY DEVICE AND CONTROL METHOD THEREOF

(71) Applicants: Inventec (Pudong) Technology Corporation, Shanghai (CN); Inventec Corporation, Taipei (TW)

(72) Inventor: Chine-Hsum WU, Taipei (TW)

(73) Assignees: Inventec (Pudong) Technology Corporation, Shanghai (CN); Inventec Corporation, Taipei (TW)

(21) Appl. No.: 14/247,860

(22) Filed: Apr. 8, 2014

(30) Foreign Application Priority Data
Nov. 29, 2013 (CN) 201310628345.7

(51) Int. Cl. G06F 3/00; G09G 5/00; G06K 9/00; G06F 3/01; G06T 3/60

(52) U.S. Cl. CPC G06F 3/005; G06F 3/013; G06T 3/60; G06K 9/00221; G09G 5/00; G09G 2354/00

(57) ABSTRACT

The disclosure a display device and a control method thereof, and the display device includes a display module, an image capturing module, a control module and a driving module. The image capturing module and the display module are disposed at a first side of the display device. The control module electrically connects to the image capturing module. The driving module electrically connects to the control module and supports the display module. The image capturing module captures a face of a user to generate a face image. The control module calculates an adjustment parameter according to the face image to generate a control signal specifying the adjustment parameter. The driving module adjusts a relative position between the display module and the user according to the control signal to optimize the display module to match the user.

### CROSS-REFERENCE TO RELATED APPLICATIONS

This non-provisional application claims priority under 35 U.S.C. §119(a) on Patent Application No(s). 201310628345.7 filed in China on Nov. 29, 2013, the entire contents of which are hereby incorporated by reference.

### BACKGROUND OF THE INVENTION

1. Technical Field of the Invention

The disclosure relates to a display device and a control method thereof, and more particularly to a display device and a control method thereof capable of automatically adjusting the position of a screen.

2. Description of the Related Art

All-In-One personal computers (AIO PC) assemble special designed main boards, central processing units, memories, hard disk drives and optical disk drives into their host devices of display screens, and the display screens can support touch control or not.

For AIO PC's nowadays, a display screen can not automatically adjust the distance between itself and a work surface (e.g. a tabletop) which the AIO PC is on, and the angle between itself and its user. When a user can not clearly watch images displayed by the display screen because not being at an ideal viewing position for the display screen, the user will have to adjust the display screen manually in order to clearly watch images displayed. If the user wants to stay at the ideal viewing position for the display screen all the time, the user will have to adjust the display screen very often. This makes the user inconvenient and reduces the working efficiency of the user.

### SUMMARY OF THE INVENTION

According to one or more exemplary embodiments, the disclosure provides a display device which includes a display module, an image capturing module, a control module and a driving module. The driving module supports the display module. The image capturing module captures a face image of a user. The control module calculates an adjustment parameter according to the face image to generate a control signal specifying the adjustment parameter. The driving module adjusts a relative position between the display module and the user according to the control signal to optimize the display module to match the user.

In one of the exemplary embodiments, the adjustment parameter includes at least one of a horizontal distance between the display module and the user, a vertical distance between the display module and a work surface, and an angle between the display module and the user.

In one of the exemplary embodiments, the driving module includes a first rotation structure, a first motor, a second rotation structure and a second motor. The first motor selectively drives the first rotation structure to rotate a first rotation angle in relation to the display module according to the control signal. The second motor selectively drives the second rotation structure to rotate a second rotation angle in relation to the display module according to the control signal. A direction of the first rotation angle is substantially vertical to a direction of the second rotation angle.

In the above exemplary embodiment, the first motor and the second motor are stepping motors, induction motors, synchronous motors, servomotors, linear motors or reversible motors, and the first rotation structure and the second rotation structure are slewing drives or guide rails.

In one of the exemplary embodiments, the control module is stored with a facial-feature positioning program. When the image capturing module captures the face image, the control module analyzes the face image to obtain facial-feature location information and then calculates the adjustment parameter according to the facial-feature location information through the facial-feature positioning program.

According to one or more exemplary embodiments, the disclosure also provides a control method of a display device. The control method includes: capturing a face image of a user; calculating an adjustment parameter according to the face image to generate a control signal specifying the adjustment parameter; and adjusting a relative position between the display device and the user according to the control signal to optimize the display device to match the user.

In one of the exemplary embodiments, the adjustment parameter includes at least one of a horizontal distance between the display module and the user, a vertical distance between a screen of the display module and a work surface, and an angle between the display module and the user.

In one of the exemplary embodiments, the step of calculating the adjustment parameter according to the face image further includes: analyzing the face image to obtain facial-feature location information through a facial-feature positioning program; and calculating the adjustment parameter according to the facial-feature location information.

In one of the exemplary embodiments, the control method further includes: manually adjusting the display device to locate at an ideal viewing angle for the user, before the face of the user is captured to generate the face image; and recording a relative position between the display device and the user' eyes at the ideal viewing angle.

In the above exemplary embodiment, the control method further includes: determining whether a relative position between facial-feature location information of the face image and the display device matches the ideal viewing angle for the user, before the adjustment parameter is calculated according to the face image; and if not, calculating the adjustment parameter for optimizing according to the facial-feature location information and the recorded relative position between the display device and the user's eyes.

### BRIEF DESCRIPTION OF THE DRAWINGS

The present disclosure will become more fully understood from the detailed description given herein below for illustration only and thus does not limit the present disclosure, wherein:

FIG. 1 is a block diagram of a display device according to an embodiment;

FIG. 2 is a block diagram of the driving module in FIG. 1;

FIG. 3 is a flowchart of a control method of a display device according to an embodiment; and

FIG. 4 is a flowchart of a control method of a display device according to an alternative embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

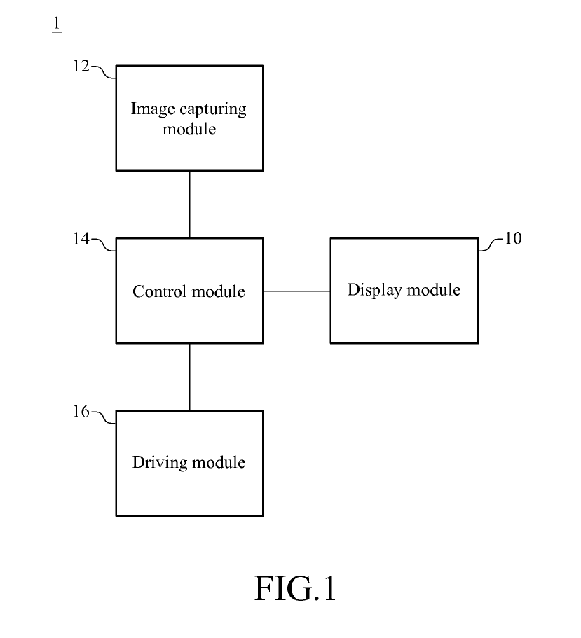

FIG. 1 is a block diagram of a display device according to an embodiment. In FIG. 1, a display device 1 mainly includes a display module 10, an image capturing module 12, a control module 14 and a driving module 16. The control module 14 electrically connects to the display module 10, the image capturing module 12 and the driving module 16. The detailed description of the display device 1 is shown below.

The display module 10 displays images provided by a host device (e.g. a desktop computer, a notebook or an AIO PC). The display module 10 can be, for example, a light emitting diode (LED) display panel, a liquid crystal displayer (LCD) or other type display panels.

The image capturing module 12 and the display module 10 are disposed at a first side of the display device 1, and can capture faces of users to generate face images. The image capturing module 12 can be, for example, an image sensor with a charge coupled device (CCD) or a complementary metal oxide semiconductor (CMOS). Moreover, the disclosure has no limitations on the locations of the image capturing module 12. The image capturing module 12 can be packaged by the casing of the display device 1, or can separate from the display device 1.

The control module 14 calculates an adjustment parameter according to the face image provided by the image capturing module 12, to generate a control signal specifying the adjustment parameter. The adjustment parameter can include, for example, a horizontal distance between the display module 10 and the user, a vertical distance between the display module 10 and a work surface (e.g. the tabletop) which the display device 1 is disposed on, and an angle between the display module 10 and the user. The angle between the display module 10 and the user herein indicates the angle between the normal line of the display surface of the display module 10 and a line of sight of the user.

Moreover, the control module 14 is stored with a facial-feature positioning program. When the image capturing module 12 captures one face image, the control module 14 will analyze the face image to generate facial-feature location information (e.g. a distance between the user' eyes, or the proportion or location of the eyes on the face) and then calculate an adjustment parameter according to the facial-feature location information through the facial-feature positioning program.

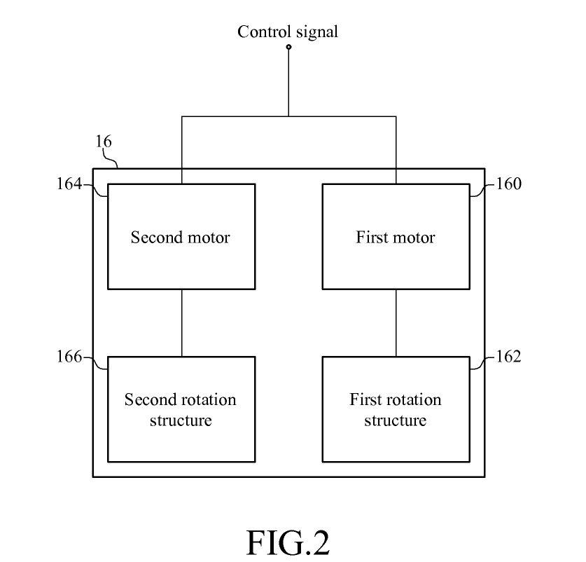

The driving module 16 can support the display module 10 to make the display module 10 stay on the work surface, and can adjust a relative position between the display module 10 and the user according to the control signal outputted by the control module 14, so as to optimize the display module 10 to match the user. Referring to FIG. 2, the driving module 16 includes a first motor 160, a first rotation structure 162, a second motor 164 and a second rotation structure 166. The first rotation structure 162 and the second rotation structure 166 are disposed at a second side of the display device 1 (i.e. the back of the screen of the display device 1), and the second side is opposite to the first side of the display device 1.

The first motor 160 is controlled according to the control signal to selectively drive the first rotation structure 162 to rotate a first rotation angle in relation to the display module 10. The second motor 164 is controlled according to the control signal to selectively drive the second rotation structure 166 to rotate a second rotation angle in relation to the display module 10. The direction of the first rotation angle is substantially vertical to the direction of the second rotation angle. In other words, the first rotation structure 162 and the second rotation structure 166 can be considered as components of a bracket of the display module 10 which control the display device 1 to rotate horizontally and vertically. The first motor 160 and the second motor 164 can be, for example, stepping motors, induction motors, synchronous motors, servomotors, linear motors or reversible motors, and the first rotation structure 162 and the second rotation structure 166 can be, for example, slewing drives or guide rails.

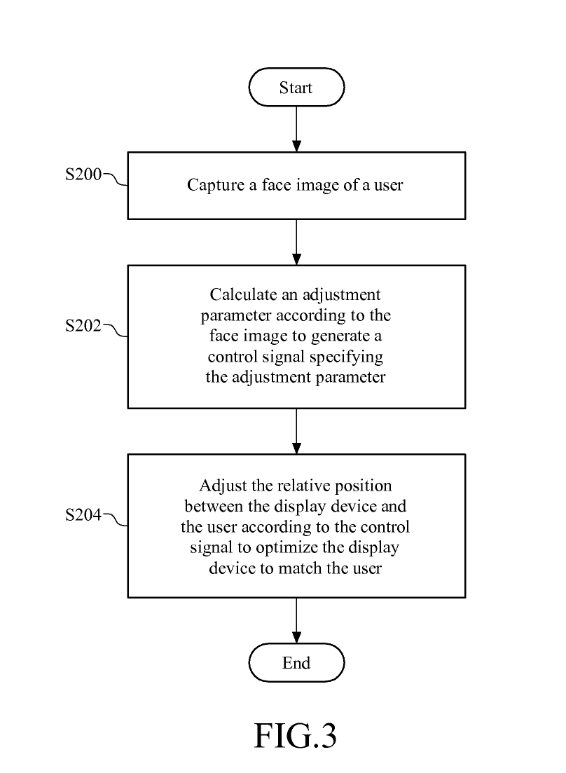

FIG. 3 is a flowchart of a control method of a display device according to an embodiment. In FIG. 3, the control method can be applied to the display device 1 in FIG. 1. As shown in step S200, the image capturing module 12 captures a face of a user to generate a face image. As shown in step S202, the control module 14 calculates an adjustment parameter according to the face image to generate a control signal specifying the adjustment parameter. The adjustment parameter can include, for example, at least one of a horizontal distance between the display module 10 and the user, a vertical distance between the display module 10 and a work surface (e.g. the tabletop), and an angle between the display module 10 and the user. As shown in step S204, the driving module 16 adjusts the relative position between the display device 1 and the user according to the control signal received from the control module 14 to optimize the display device 1 to match the user.

When the adjustment parameter is calculated according to the face image (step S202), the control module 14 employs a facial-feature positioning program to analyze the face image to generate facial-feature location information and then to calculate the adjustment parameter according to the facial-feature location information.

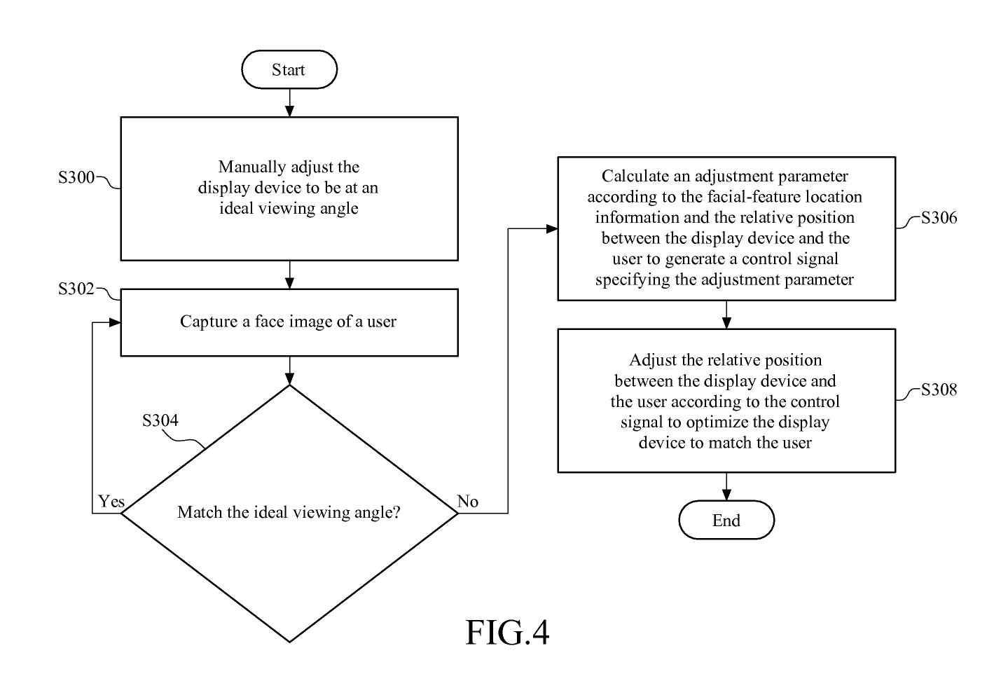

FIG. 4 is a flowchart of a control method of a display device according to an alternative embodiment. The control method can be applied to the display device 1 in FIG. 1. As shown in step S300, a user has to manually adjust the display device 1 to be at an ideal viewing angle (i.e. the beat viewing angle of the display device 1) which is the most suitable to the user, and then records a current relative position between the user' eyes and the display device 1. As shown in step S302, the image capturing module 12 captures a face of the user to generate a face image. As shown in step S304, the control module 14 determines a relative position between the display device 1 and the facial-feature location information of the face image (e.g. the distance between the two eyes, or the proportion or location of the eyes on the face) matches the ideal viewing angle. If yes, return to step S302; and if no, perform step S306.

As shown in step S306, the control module 14 calculates an adjustment parameter according to the facial-feature location information and the relative position between the display device 1 and the facial-feature location information of the face image in step S300, to generate a control signal specifying the adjustment parameter. As shown in step S308, the driving module 16 adjusts the relative position between the display device 1 and the user according to the control signal to optimize the screen of the display device 1 to match the user.

In view of the above description, the disclosure provides the display device and the control method thereof, which can determine whether the head of a user is at an ideal viewing position of the display device according to a face image captured by the image capturing module, can calculate an adjustment parameter when the head of the user is not at the ideal viewing position of the display device, and can employ the driving module to adjust the relative position between the display device and the user according to the adjustment parameter, to optimize the display device to match the user. In this way, the display device and the control method can automatically track the face of the user to automatically adjust the relative position between the display device and the user in real time. Therefore, the user may watch the display device comfortably.

What is claimed is:

1. A display device, comprising:
a display module;
an image capturing module, configured to capture a face image of a user;
a control module, configured to calculate an adjustment parameter according to the face image to generate a control signal specifying the adjustment parameter; and
a driving module, configured to support the display module and adjust a relative position between the display module and the user according to the control signal so as to optimize the display module to match the user.

2. The display device according to claim 1, wherein the adjustment parameter comprises at least one of a horizontal distance between the display module and the user, a vertical distance between the display module and a work surface, and an angle between the display module and the user.

3. The display device according to claim 1, wherein the driving module comprises:
a first rotation structure;
a first motor, configured to selectively drive the first rotation structure to rotate a first rotation angle in relation to the display module according to the control signal;
a second rotation structure; and
a second motor, configured to selectively drive the second rotation structure to rotate at a second rotation angle relative to the display module according to the control signal;
wherein a direction of the first rotation angle is substantially vertical to a direction of the second rotation angle.

4. The display device according to claim 3, wherein the first motor and the second motor are stepping motors, induction motors, synchronous motors, servomotors, linear motors or reversible motors, and the first rotation structure and the second rotation structure are slewing drives or guide rails.

5. The display device according to claim 1, wherein the control module is stored with a facial-feature positioning program, when capturing the face image, the control module analyzes the face image to obtain facial-feature location information through the facial-feature positioning program, and the control module further calculates the adjustment parameter according to the facial-feature location information.

6. A control method for a display device, comprising:
capturing a face image of a user;
calculating an adjustment parameter according to the face image to generate a control signal specifying the adjustment parameter; and
adjusting a relative position between the display device and the user according to the control signal so as to optimize the display device to match the user.

7. The control method according to claim 6, wherein the adjustment parameter comprises at least one of a horizontal distance between the display device and the user, a vertical distance between a screen of the display device and a work surface, and an angle between the display device and the user.

8. The control method according to claim 6, wherein the step of calculating the adjustment parameter according to the face image further comprises: analyzing the face image to obtain facial-feature location information through a facial-feature positioning program; and calculating the adjustment parameter according to the facial-feature location information.

9. The control method according to claim 6, further comprising:
manually adjusting the display device to locate the display device at an ideal viewing angle for the user, before the face of the user is captured to generate the face image; and
recording a relative position between the display device and the user's eyes at the ideal viewing angle.

10. The control method according to claim 9, further comprising:
determining whether a relative position between facial-feature location information of the face image and the display device matches the ideal viewing angle for the user, before calculating the adjustment parameter according to the face image; and
if no, calculating the adjustment parameter for optimizing according to the facial-feature location information and the recorded relative position between the display device and the user's eyes.
